(19) United States
(12) Patent Application Publication
(10) Pub. No.: US 2002/0109886 A1
(43) Pub. Date: Aug. 15, 2002

(54) Window-mounted free-space optical wireless communication system

(76) Inventors: Pierre Robert Barbier, Oviedo, FL (US); William Joseph Lauby, Mukilteo, WA (US); Scott William Sparrold, Tucson, AZ (US); Eric Joseph Davis, Redmond, WA (US); Steven Andrew Cashion, Redmond, WA (US); Nicholas Eichhorn Bratt, Edmonds, WA (US); James Joseph Herbert, Denver, CO (US); Eric Lawrence Upton, Bellevue, WA (US); David Lawrence Rollins, Woodinville, WA (US); Mark Lewis Plett, Redmond, WA (US)

Correspondence Address: Dennis M. de Guzman, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/043,596

(22) Filed: Jan. 9, 2002

Related U.S. Application Data
(60) Provisional application No. 60/263,459, filed on Jan. 22, 2001.

(51) Int. Cl. H04B 10/00

(52) U.S. Cl. 359/172; 359/159

(57) ABSTRACT

A compact, lightweight free-space optical communication system is mounted to a window, such as to a surface of the window. Mounting can be accomplished using glue, vacuum devices, or other fastener devices or fixtures. The optical communication system has features that compensate for window dynamics and other window characteristics, including fast steering solutions for pointing and tracking, and terminal size and weight factors.

### CROSS-REFERENCE TO RELATED APPLICATION

The present application claims priority to U.S. Provisional Application Serial No. 60/263,459, entitled “Window-Mountable Free-space Optical Wireless Communication System,” filed Jan. 22, 2001, with inventors Pierre Robert Barbier, William Joseph Lauby, Scott William Sparrold, Eric Joseph Davis, Steven Andrew Cashion, Nicholas Eichhorn Bratt, James Joseph Herbert, Eric Lawrence Upton, David Lawrence Rollins, and Mark Lewis Plett, assigned to the same assignee as the present application, and which is incorporated herein by reference in its entirety.

### TECHNICAL FIELD

The present disclosure is related generally to optical communication systems, and in particular but not exclusively, relates to a window-mounted optical communication system.

### BACKGROUND INFORMATION

Optical wireless communication is achieved by optically aligning two terminals with each other across free-space over a distance up to several kilometers. A modulated optical signal (or beam) is sent from the transmitter of one of the terminals to the receiver of the opposite terminal. One of the functions of an optical wireless terminal is to convert an incoming signal from communication equipment into a free-space optical signal and to transmit the resulting optical beam through transmit optics onto the receive optics of the opposite terminal, while simultaneously being able to receive an incoming optical beam from the opposite terminal and to convert that optical beam into a signal for the communication equipment. The communication equipment includes routers, switches, or other devices, which can be directly connected to a communication line.

Another function of a free-space optical communication system is to maintain alignment between two opposed terminals and to compensate for external effects such as vibrations and structure sway, which may result in mis-pointing and downtime during which data is not transmitted. Typically, the terminals are mounted on an architectural structure close to the network equipment.

One of the major issues in using optical wireless communication systems is mounting the system onto existing architectural structures to obtain a direct line-of-sight between the terminals. These structures include, but are not limited to, walls, roofs, and metal trusses (such as antennas). Architectural structures sway under the effect of sun-resulting temperature gradients, external forces such as wind, phreatic water pressure changes, sleet, snow, etc. In addition, architectural structures vibrate under the effects of human, mechanical, or natural phenomena. Building sway and vibration can cause optical terminals to sway and vibrate as well, which can result in mis-pointing error between the two optical terminals, and thus may create communication signal losses.

Some free-space optical communication systems have been designed for roof mounting. This solution aids in obtaining a direct line-of-sight and results in a minimum power penalty in comparison with mounting the terminals indoors behind windows, which attenuate the signal. However, roof-mounted systems are exposed to the powerful effects of wind gusts and weather. These effects result in vibrations of the terminals and mis-pointing of the optical beam.

A conventional solution to compensate for these conditions is to increase the divergence of the transmitted beam and the field of view of the receiver. Such solution comes at the cost of an optical power penalty from the geometrical spread of the divergent beam and from the degradation of the receiver sensitivity as more background light reaches the optical detector. The loss of optical power results in reduced link range, which can significantly increase cost of deployment, or result in denial of service for customers outside of the range. Moreover, it is desirable to restrict access in front of the transmitting terminal.

Another potential solution for overcoming the effects of an outdoor mounting is the addition of an active pointing and tracking system to the communication terminals. Such a system can be made to maintain the terminal alignment under most conditions—however its addition to the terminal may increase its size and generally substantially increases its cost.

Roof-mounted systems are also undesirable because of complications and costs associated with obtaining roof access rights, with complying with architectural aesthetics codes, with providing lightning protection and a mounting structure, and with solving environmental exposure issues to enable cost effective and reliable installation of roof-mounted systems. Finally, a data line must be installed between the roof-mounted communication system and the user's network equipment, thereby incurring cost and additional installation time.

To avoid such installation problems related to roof access and environmental conditions (such as wind), the transceivers can be installed indoors in the office environment such that they transmit and receive through windows (although transceivers installed indoors may also be affected by building expansion and sway). To do this, the optical communication terminals should be mounted as close as possible to the window to ensure that the communication laser beam does not become obstructed by human activity and that laser eye safety limits are not compromised. A terminal that is mounted some distance from a window presents an opportunity for personnel access to the laser beam, either from direct viewing or by way of reflections from the window surface. This situation must be guarded against by either limiting laser power with subsequent reduction in link power budget and range, or by restricting access to the area, which requires installation of substantial physical barriers. These solutions are undesirable because of their cost and impact to the user environment.

Some mounting solutions include mounting the terminal directly onto the floor using a pedestal. This solution requires restricted-access floor space around the window, which results in encroachment of valuable and desirable floor space needed for office employees. Additionally, the pedestals and terminals are still subject to sway and vibrations that the floor experiences.

Alternatively, terminals could be mounted directly onto the walls, columns, or ceiling adjacent to the window. However, architectural environments may make access to and fastener penetration of these elements difficult or impossible because of building structural integrity requirements, rendering the implementation of these mounting solutions impractical. In addition, the configuration and condition of these architectural structures are variable, random, and unknown, thereby requiring a customized installation at every location with its associated design, fabrication, and installation cost and time penalty.

### BRIEF DESCRIPTION OF THE DRAWINGS

Embodiments of the present invention are best understood by reference to the figures wherein references with like reference numbers generally indicate identical, functionally similar, and/or structurally similar elements. The drawing in which an element first appears is indicated by the leftmost digit(s) in the reference number in which:

FIG. 1 shows a window suitable for implementing aspects of the present invention;

FIG. 2 is a high-level block diagram of an optical communication system suitable for implementing aspects of the present invention;

FIG. 3 is an example of an optical communication terminal suitable for use in the system depicted in FIG. 2;

FIG. 4A is a side view of an optical communication terminal suitable for implementing aspects of the present invention;

FIG. 4B is a front view of the optical communication terminal shown in FIG. 4A;

FIG. 5A is a side view of another embodiment of an optical communication terminal;

FIG. 5B is a front view of the optical communication terminal shown in FIG. 5A;

FIG. 6A is a side view of another embodiment of an optical communication terminal suitable for implementing aspects of the present invention;

FIG. 6B is a front view of the optical communication terminal shown in FIG. 6A;

FIG. 7A is a side view of another embodiment of an optical communication terminal suitable for implementing aspects of the present invention;

FIG. 7B is a front view of the optical communication terminal shown in FIG. 7A;

FIG. 8 shows an example mounting in which an optical communication terminal is mounted at a ninety-degree angle with a window;

FIG. 9 shows an embodiment having separate optic and electronic subassemblies;

FIG. 10 is a flow chart illustrating an approach to optical communications using a window mountable optical communication terminal;

FIG. 11 is a perspective view of several free-space optical terminals mounted to building window partitioned into several regions;

FIG. 12 is a perspective view of several free-space optical terminals mounted to several building windows by coupling to a ceiling fixture, a wall fixture, a frame fixture, and a corner fixture; and

FIG. 13 is a perspective view of a free-space optical terminal mounted to a building window using a floor fixture.

### DETAILED DESCRIPTION OF THE ILLUSTRATED EMBODIMENTS

Mounting a compact and lightweight free-space optical communication terminals directly onto a window surface or a window frame is described herein. In the following description, numerous specific details are provided, such as particular processes, programming, components, etc., to provide a thorough understanding of embodiments of the invention. One skilled in the relevant art will recognize, however, that the invention can be practiced without one or more of the specific details, or with other methods, components, etc. In other instances, well-known structures or operations are not shown or described in detail to avoid obscuring aspects of various embodiments of the invention.

Some parts of the description will be presented using terms such as mirror, optical detector, telescope, periscope, transmitter, receiver, line-of-sight, and so forth. These terms are commonly employed by those skilled in the art to convey the substance of their work to others skilled in the art.

Other parts of the description will be presented in terms of operations performed by a computer system, using terms such as pointing, tracking, acquiring, transmitting, receiving, and so forth. As is well understood by those skilled in the art, these quantities and operations take the form of electrical, magnetic, or optical signals capable of being stored, transferred, combined, and otherwise manipulated through mechanical and electrical components of a computer system; and the term “computer system” includes general purpose as well as special purpose data processing machines, systems, and the like, that are standalone, adjunct or embedded.

Reference throughout this specification to “one embodiment” or “an embodiment” means that a particular feature, structure, process, step, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Various operations will be described as multiple discrete steps performed in turn in a manner that is most helpful in understanding the invention. However, the order in which they are described should not be construed to imply that these operations are necessarily order-dependent or that the operations be performed in the order in which the steps are presented.

According to an aspect of the present invention, a free-space optical communication terminal includes a window fixture to mount the free-space optical communication terminal to a building window for transmitting and receiving a light (or laser) beam. Mounting a terminal to a building window takes advantage of the dynamics of the building window. For example, and in contrast to other mounting techniques, the building window presents a constant in that they are most commonly placed in a vertical attitude, are of a known material, and present a substantially smooth and uniform surface. Building windows are built into the wall structure and generally provide a recessed area outside of the useful floor space envelope. Building windows are almost always mounted in frame systems, which are generic in design and configuration, thereby presenting a constant, predictable environment. This well-understood and predictable environment is beneficial to simplification of equipment designs and efficient, ergonomic implementation of free space communication systems.

One aspect of the present invention mounts a free-space optical communication terminal to a window frame for transmitting and receiving a light (or laser) beam. During operation, the beam is transmitted from one window frame-mounted optical communication terminal either through the window, if mounted indoors, or directly into free space, if mounted outdoors. The beam is received by another optical communication terminal located opposite the transmitting window frame-mounted optical communication terminal. The optical terminal on the receive end may or may not be window frame-mounted.

Other aspects provide pointing and tracking solutions that enhance beam alignment performance to compensate for window dynamics or other window characteristics. The techniques and solutions address problems such as terminal weight, terminal size, and window vibrations.

When an optical communication terminal is mounted to a window, the optical communication terminal is small and lightweight in one embodiment. The purposes of these features are to minimize the stresses imposed on the window (e.g., the weight of the communication terminal is selected to be within stress limits of the window), to reduce the obstructed view through the window, and to reduce the mass subject to window dynamics.

To reduce the size and weight of the optical communication terminal, in one embodiment, a common telescope aperture is used to transmit and to receive beams. The common telescope aperture also enables fast pointing and tracking of the transmitted and received beams using a single fast steering system, as compared to multi-aperture systems where separate steering systems are needed for each aperture.

Other techniques to reduce the optical communication terminal weight include folding the optical path the beam takes when it enters the optical communication terminal and travels to the optical detector. Typically, the optical communication terminal protrudes a certain distance from the window to be compatible with the focal length of the lenses used in the optics. The optical path can be folded multiple times inside the optical communication terminal to change the form factor of the optical assembly thereby allowing a smaller package. Folding can be accomplished using mirrors, prisms, or through optimization of lenses. This reduction in focal length allows, for instance, the optical communication terminal to be mounted (in a substantially flat manner) onto a windowpane or window surface without interfering with operation of blinds, drapes, or curtains.

Pointing and tracking solutions enhance beam alignment performance to compensate for window dynamics. These include the use of fast steering systems that compensate for window vibration that are typically high frequency vibrations, due to environmental factors such as wind. In contrast, walls, floors, and other building structures typically have lower frequency vibrations.

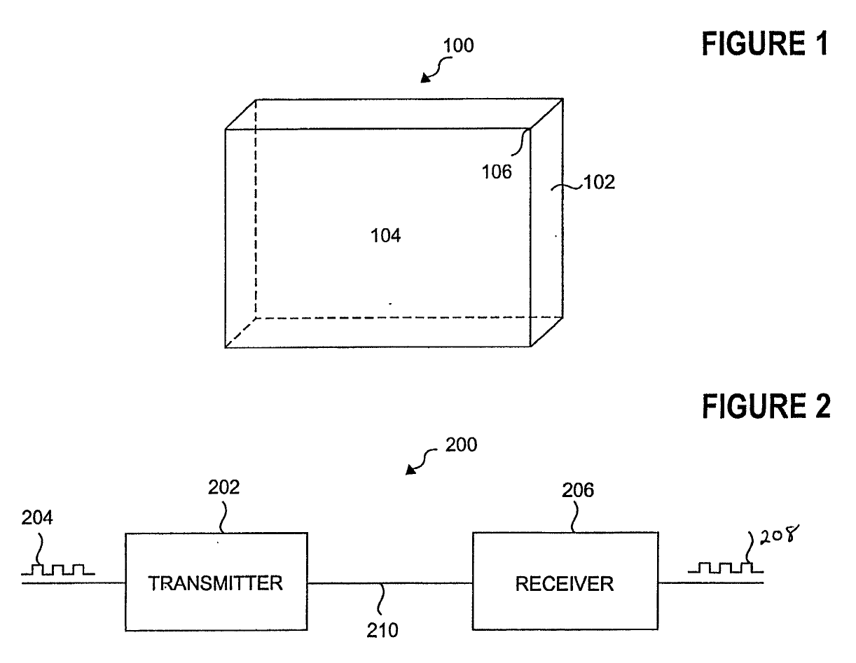

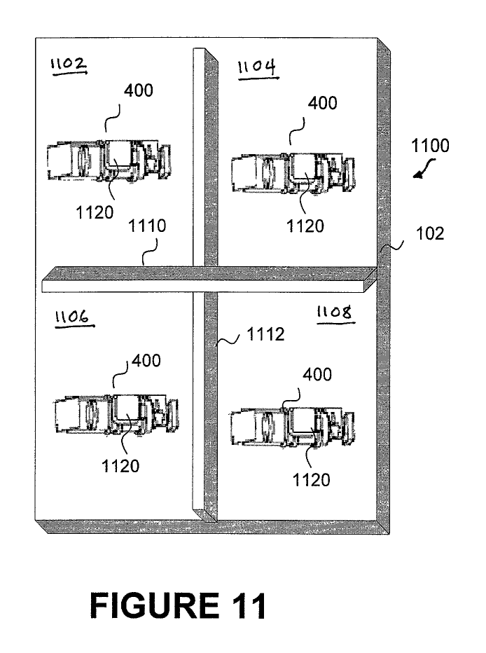

FIG. 1 shows a window 100 to which an optical communication terminal can be mounted. The window 100 includes window frame 102, windowpane 104, and window corner 106. To limit the effect of window deflections on pointing, the optical communication terminal may be mounted in the window corner 106 at a right angle to benefit from the rigidity of the window frame 102. In one embodiment, the window 100 may be partitioned into two or more sections using dividers to take advantage of the rigidity afforded by having more than four corners. For example, when the window 100 is partitioned into four sections, an optical communication terminal may be mounted near a corner of each section. Mounting of one or more optical terminals according to this and other embodiments is described with reference to FIG. 11.

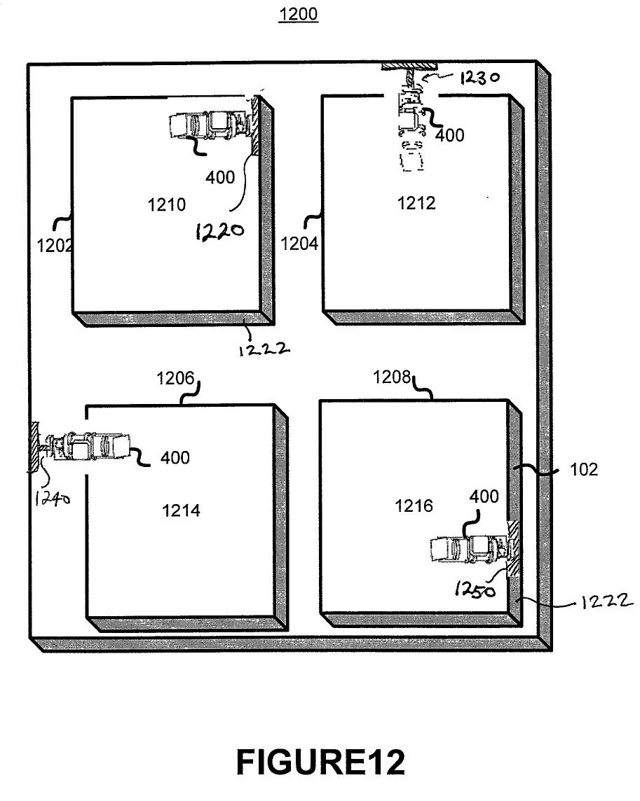

In still another embodiment, the optical communication terminal is mounted onto a wall and or ceiling structure next to the window 100. A bracket can be used to suspend the terminal from the wall or ceiling and to place the optical communication terminal in front of the window 100. In this and other embodiments, the optical communication terminal (and/or at least a portion thereof) may be in contact with (e.g., pressed against) the windowpane 104 to mechanically isolate the optical communication terminal from the bracket, and thus have the optical communication terminal take advantage of the characteristics of the window rather than the bracket (and wall/ceiling). Mounting of one or more optical terminals according to this and other embodiments is described with reference to FIG. 12.

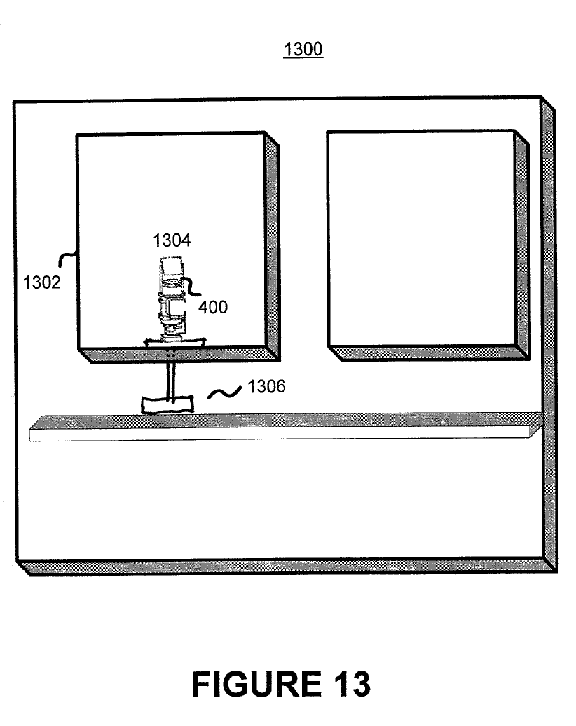

In another embodiment, the optical communication terminal may be mounted on the floor or any other architectural structure using a mounting fixture (e.g., a pedestal). In this embodiment, the optical communication terminal may be pressed against or otherwise have at least a portion thereof in contact with the windowpane 104 to mechanically isolate the optical communication terminal from the mounting fixture, and thus have the optical communication terminal take advantage of the characteristics of the window rather than the mounting fixture (and floor). Mounting of one or more optical terminals according to this and other embodiments is described with reference to FIG. 13.

FIG. 2 is a high-level block diagram of an optical communication system 200 suitable for implementing aspects of the present invention. A transmitter 202 converts an incoming electrical signal 204 into an optical signal 210, sends the optical signal through optics, and transmits the optical signal to a receiver 206. Optics in the receiver 206 collect, focus, etc., the incoming optical signal and convert it to an electrical signal 208. The electrical signal 204 generally originates in communication equipment and terminates at communication equipment. Typical communication equipment includes routers, switches, or other devices that can be directly connected to a communication line.

A physical connection 210 is shown between the transmitter 202 and the receiver 206. The connection 210 is intended to represent the transmission medium for the optical signal. In one embodiment, the transmission medium is an optical fiber. In another embodiment, the transmission medium depicted by the connection 210 is free space.

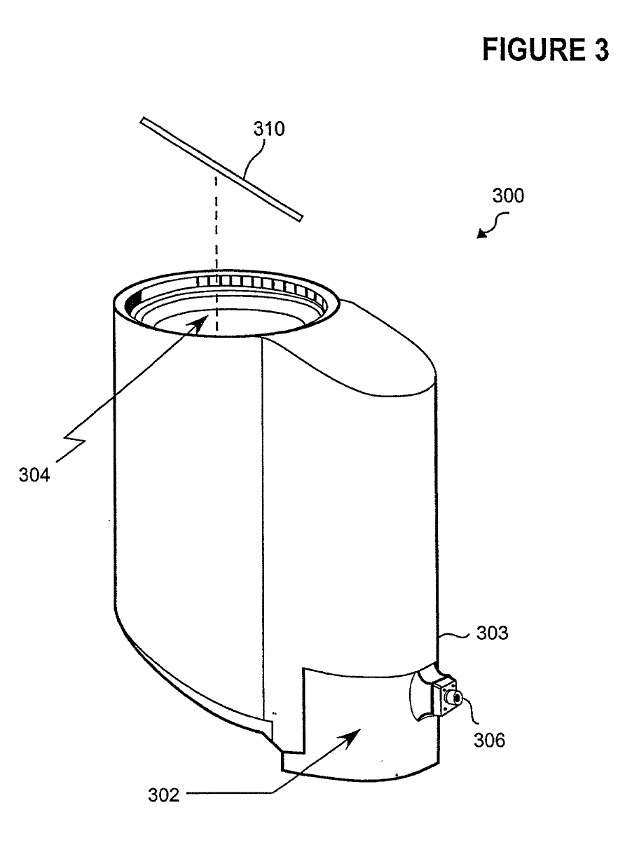

A transmitter 202 and a receiver 206 can be embodied in a single optical communication terminal (e.g., a transceiver). FIG. 3 illustrates an example optical communication terminal 300. Each optical communication terminal 300 has both transmitting and receiving capabilities, and includes components such as optics (telescopes, lenses, mirrors, beam splitters, etc.), electronics (lasers, transmitters, detectors, receivers), mechanical components (gimbals, gears, etc.), and so forth. It is to be appreciated that in other embodiments, the optical terminal 300 may have only receive capabilities or only transmit capabilities. The optical communication terminal 300 includes electronics 302 integrated with the optical subassembly (e.g., a telescope 304), and the output is a fast Ethernet port 306 in one embodiment. The optical communication terminal 300, in one embodiment, is approximately five inches wide, nine inches tall, and seven inches deep. Other embodiments are smaller or larger (e.g., 200 in³, 400 in³, and so forth).

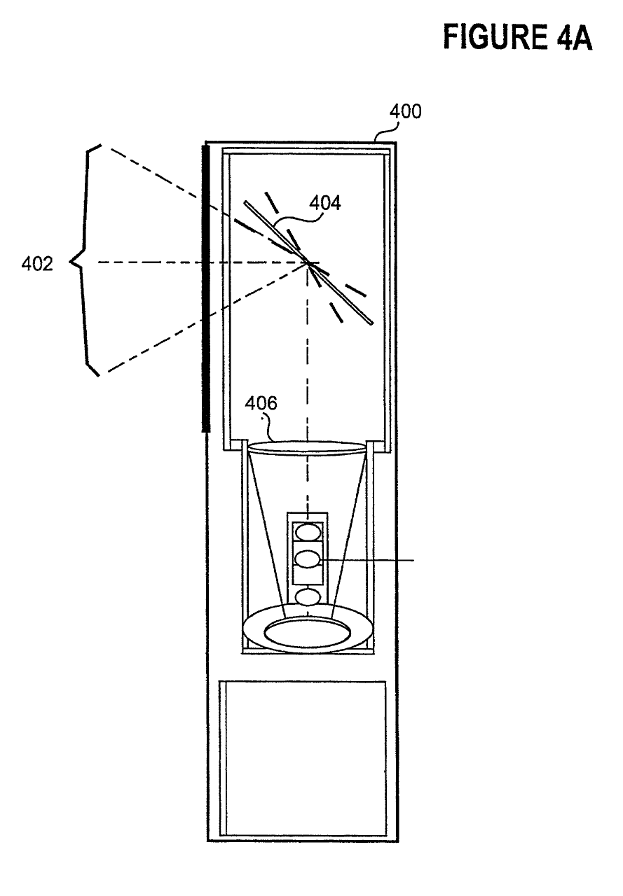

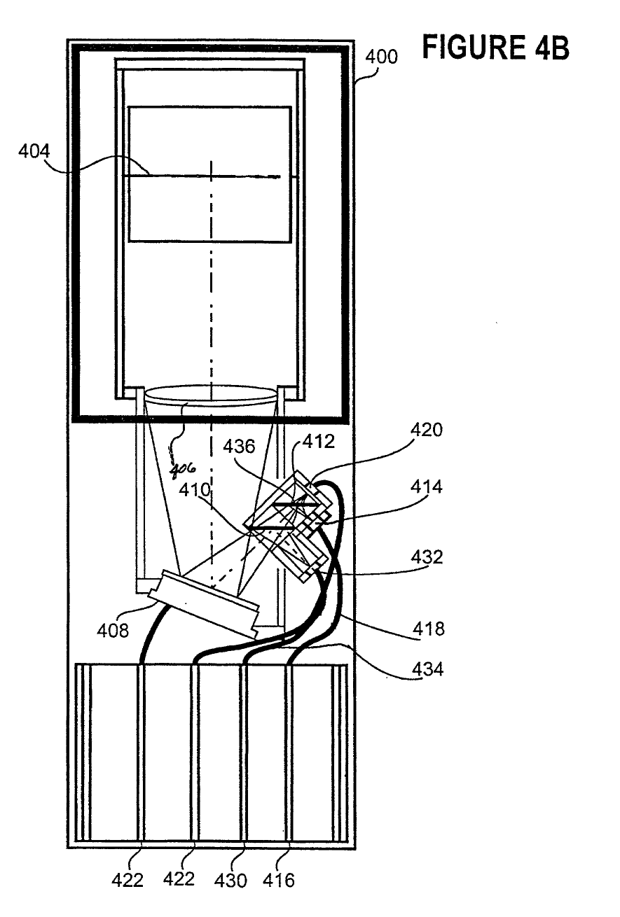

FIGS. 4A and 4B show an example embodiment of an optical communication terminal 400 that is compatible with the 1550 nm bandwidth of an erbium-doped fiber amplifier (EDFA). This embodiment permits a beam 402 to access the high-speed optical communication components within the terminal 400. Other embodiments are compatible with other wavelengths and, reading the description provided herein, a person of ordinary skill in the art could readily implement the present invention with other wavelengths. FIG. 4A is a side view and FIG. 4B is a front view of the terminal 400.

In this embodiment, the transmit beam and receive beam share the same path and thus the same optics and, for purposes of explanation, the terminal 400 is sometimes described with reference to one beam 402. It is to be understood, however, that the beam 402 includes both a transmit beam and a receive beam.

Referring in particular to FIG. 4B, the terminal 400 includes a mirror 404, a lens 406, a mirror 408, two beam splitter/combiners 410 and 412, a detector 414, receiver electronics 416, an optical fiber (or electrical cable) 418, a quad cell 420, tracking electronics 422, transmitter opto-electronics 430, a laser 432, and an optical fiber or electrical cable 434 to launch the transmit beam or drive the laser 432, respectively. In another embodiment, the laser 432 is integrated into the transmitter opto-electronics 430 and connected to the optics portion of the terminal 400 via an optical fiber. It is to be appreciated that these components are merely illustrative of an embodiment, and that other embodiments may have more (or fewer) components and that such components may be arranged differently.

The receive beam enters the terminal 400 and goes through the mirror 404. The mirror 404 behaves like a periscope to point or steer the receive beam along two axes (“x” and “y”). In this manner, the mirror provides course alignment for the beam 402.

The mirror 404 steers the beam 402 to the lens 406, which focuses the received beam onto one or more mirrors, one of which is the mirror 408. The received beam also is focused into a beam splitter/combiner 410 and a beam splitter/combiner 412, which separate and/or combine the receive beam and the transmit beam. In one embodiment, the beam splitters/combiners 410 and 412 comprise dichroic optical beam splitter/combiners.

The receive beam travels through the beam splitters/combiners 410 and 412. There may be a bandpass optical filter 436 after the beam splitter/combiner 410 to filter out unwanted signals at the receiver from the transmit beam.

The major portion of the received beam is collected by the detector 414, and the resulting electrical signal is sent on to the receiver electronics 416 via the electrical cable 418. In one embodiment, the detector 414 comprises an avalanche photodiode (APD). Alternatively, the receive beam travels through the beam splitters/combiners 410 and 412 and is launched into an optical fiber 418.

In a transmit mode, the transmitter opto-electronics 430 may send a signal to the laser 432, which converts the electrical signal to a transmit beam. The transmit beam is combined with the receive beam by the beam splitters/combiners 410 into the beam 402. The beam 402 is sent to the mirror 408, collimated by the lens 406, and steered by the mirror 404 out into free space. In one embodiment, the outgoing beam 402 can be slightly diverged by changing the distance between the lens 406 and the detector 414, the quad cell 420, and the laser 432 to optimize pointing and tracking performance at the opposing optical terminal.

Alternatively, the transmitter opto-electronics 430 sends an optical signal to the beam splitters/combiner 410 via an optical fiber 434. The transmit beam is combined with the receive beam by the beam splitters/combiner 410 into the beam 402. The beam 402 is focused onto the mirror 408, collimated by the lens 406, and steered by the mirror 404 out into free space.

In operation, one terminal mounted on one window attempts to communicate with another terminal mounted on another window. Both terminals are transmitting to each other and receiving from each other, and their beams 402 must track, else communication may be non-optimal. The beams must also be properly pointed at its opposite terminal.

In one embodiment, the terminal 400 includes a fast tracking system, which compensates for tracking deviations in a window-mounted implementation. Mounting terminals to windows poses unique tracking and pointing problems to overcome because windows are subject to various types of vibrations as they pick up structural vibrations, sound waves, wind gusts, etc. These vibrations can be in the 100 Hz range or higher and cause the beam 402 to mis-point, which means that the transmit beam 402 may miss the receiver target by several milliradians. Vibrations also can cause the receive beam 402 to be improperly or insufficiently tracked by the terminal 400, which means that the beam 402 misses its target (e.g., the detector 414, or the optical fiber 418).

There are several unwanted effects of improper pointing and tracking. One is that the optical power budget is reduced. Another is that the maximum distance at which communication is achieved is reduced. A third effect of improper pointing and tracking is that the fog attenuation conditions over which the optical communication system 200 can be used are limited. Having a free-space optical communication terminal mounted to a window also contributes to mis-pointing and mis-tracking—a problem that an embodiment of the invention addresses with a fast tracking system suitable for window-mounted implementations.

Broadening the divergence of the beam mitigates the effects of mis-pointing the beam. This solution, however, increases the geometric optical losses of the optical communication system 200 and reduces the maximum distance at which communication is achieved. Mis-tracking of the beam can be mitigated by broadening the instantaneous field-of-view at the receiver. This solution, however, degrades the receiver sensitivity because broadening the instantaneous field-of-view causes more background light to be collected by the optical detector.

To increase the power budget, a high-speed (e.g., greater than 100 Hz in one embodiment) pointing and tracking system in the optical communication terminal 400 compensates for window vibrations. The pointing and tracking system is based on a fast steering mechanism and an angle-of-arrival sensing element in an embodiment.

In the receive direction, the pointing and tracking system detects the angle of arrival of the incoming beam 402 and modifies the internal alignment of the optical communication terminal 400 to maximize the optical power reaching the target (e.g., the optical detector 414 or optical fiber 418). Conversely, when the transmitted beam is properly tracked, the transmitted beam is properly pointed onto the receiving target in the opposite optical communication terminal.

A fast tracking system can be implemented using a position sensor, a controller, and a fast steering mechanism. Position sensors can be any suitable well-known or future position sensors that are sensitive to the wavelength coming from the opposite optical communication terminal. Suitable position sensors include, but are not limited to, quadrant-cell detectors (quad cell), lateral effect cells (LEC), fast charge coupled devices (CCDs), and complementary metal oxide semiconductor (CMOS) cameras.

The controller can be any suitable well-known or future controller. Examples of suitable controllers include a microprocessor, a digital signal processor (DSP) chip, and/or a field programmable gate array (FPGA).

The fast steering mechanism can be any suitable well-known or future fast steering mechanism. Suitable fast steering mechanisms include a fast steering mirror, a lens, or a gimbal system with actuators to rotate the optical subassembly.

In the embodiment depicted in FIG. 4B, the fast steering mechanism is implemented in the mirror 408, and the position sensor is implemented in the quad cell element 420. A fraction of the received beam travels to the quad cell element 420 and is processed using the tracking electronics 422 (e.g., a controller, a processor, and the like). In this embodiment, the mirror 408 compensates for tracking deviations and maintains the alignment of the beam within the optical communication system 200. As a result, if the window vibrates, the fast steering system ensures that the transmit beam is not steered away from the opposite receiver and that the receive beam is focused on the center of the quad cell element 420.

For example, when the angle of the receive beam changes, the mirror 408 physically moves to change the angle of the receive beam incident on the mirror 408 to keep the receive beam centered on the quad cell element 420. The quad cell element 420 functions as a feedback mechanism.

Recall that in one embodiment, the transmit beam and the receive beam share the same optics and are separated within the terminal 400. The transmit beam and the receive beam are separated using wavelength gendering to minimize the fraction of the transmit beam that is reflected back onto the receiver. Other gendering techniques can be used as well, such as polarization gendering.

In one embodiment, a bandpass optical filter (not shown) follows the beam splitter/combiner 410 and a periscope (not shown) folds the beam 402 by ninety degrees, plus or minus forty-five degrees, in any of several possible directions. In this particular implementation, the optical communication system 200 is a focal optical communication system to limit the number of components. Identical performance can be achieved using an afocal optical communication system, which permits higher isolation ratios between the transmitter and the receiver by using beam splitters with collimated beams.

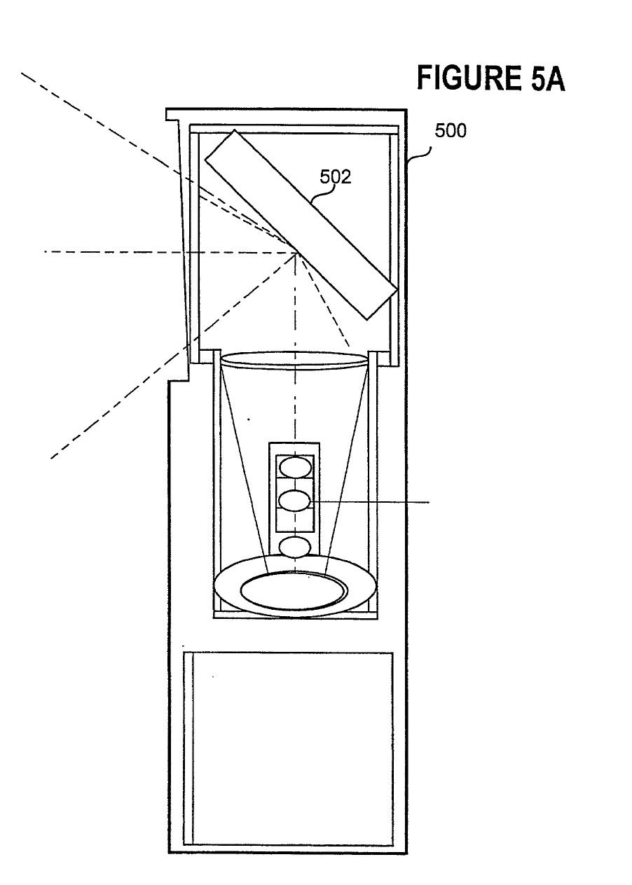

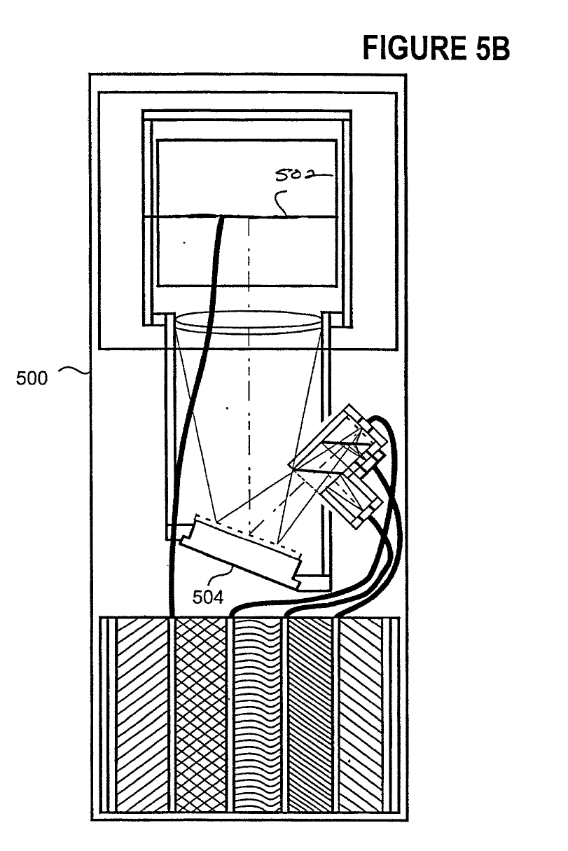

FIG. 5A is a side view of another embodiment of an optical communication terminal 500, and FIG. 5B is a front view thereof. The terminal 500 is similar to the terminal 400, except that the terminal 500 has a fast steering mirror 502 in place of the (periscope) mirror 404. Additionally, the terminal 500 has a fixed mirror 504 in place of the (fast steering) mirror 408.

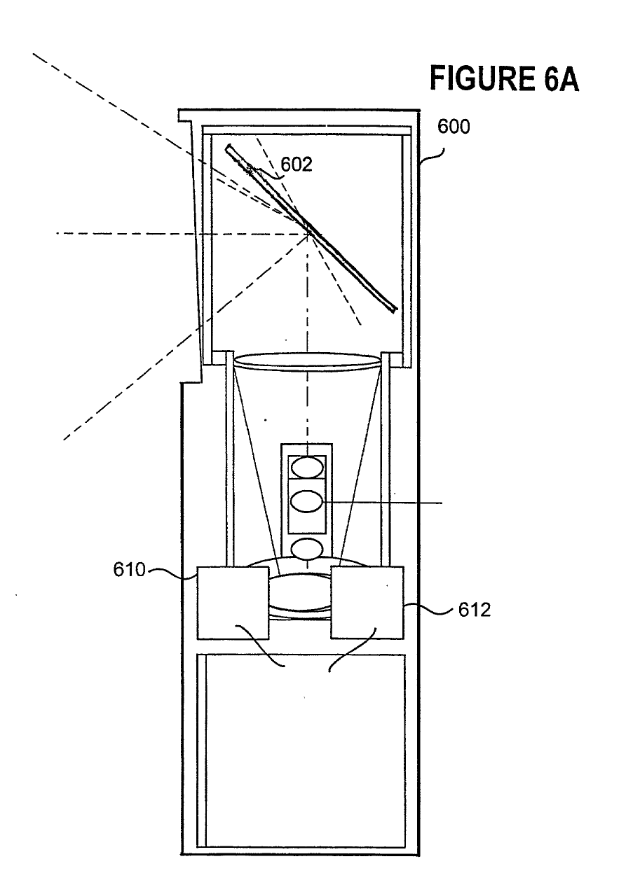

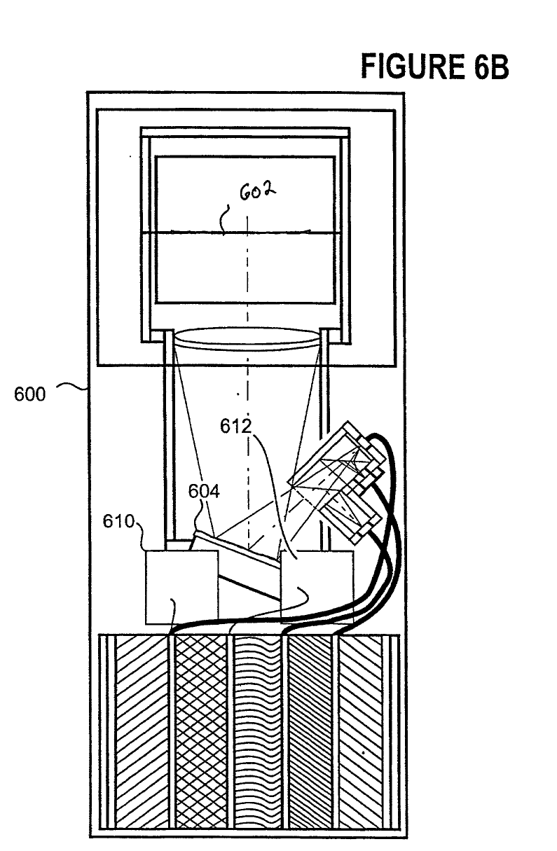

FIG. 6A is a side view of another embodiment of an optical communication terminal 600, and FIG. 6B is a front view thereof. The terminal 600 is similar to the terminal 400, except that the terminal 600 has two fixed mirrors 602 and 604 in place of the (periscope) mirror 404 and the (fast steering) mirror 408. The optical assembly is steered using actuators 610 and 612, which may be driven by stepper motors or other suitable precision motion device(s).

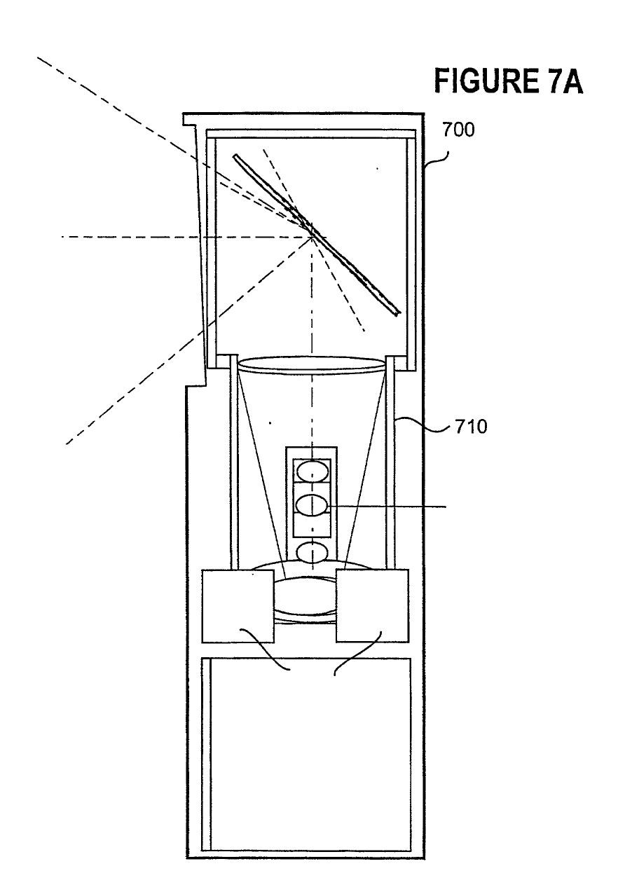

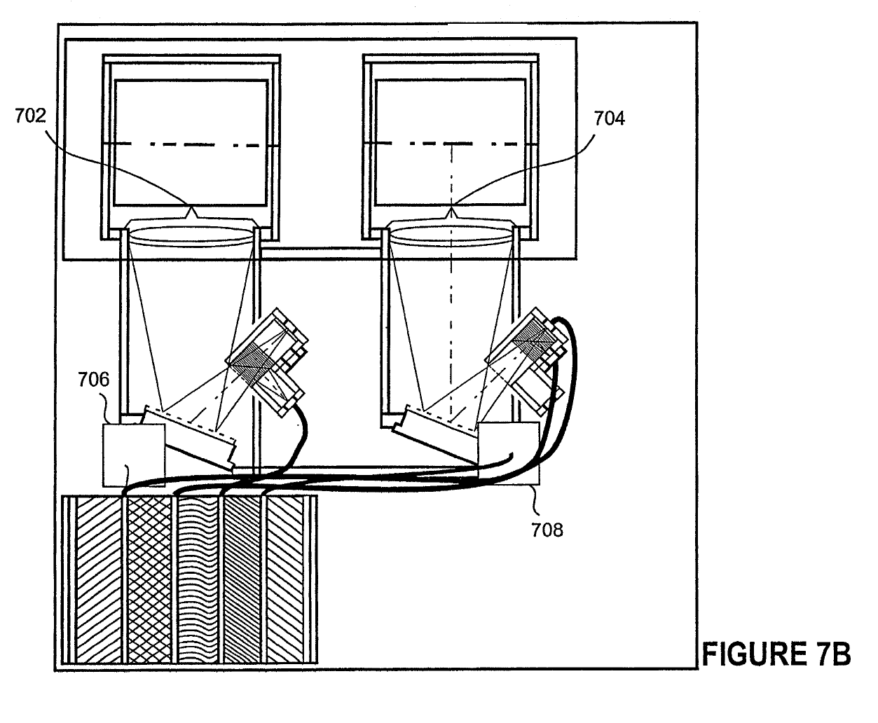

FIG. 7A is a side view of another embodiment of an optical communication terminal 700, and FIG. 7B is a front view thereof. The terminal 700 is similar to the terminal 400, except that the terminal 700 has separate telescope apertures, a transmit aperture 702 and a receive aperture 704. This binocular-type terminal achieves optical isolation between the transmitter and the receiver portions of the terminal 700. An optical subassembly 710 is steered using actuators 706 and 708, which may be driven by stepper motors.

Any of the embodiments of the optical terminals shown in FIGS. 5A-5B, 6A-6B, and 7A-7B may be mounted to the window 100. These optical terminals may be provided with suitable steering mechanisms, mounting mechanisms, or size, shape, and weight that can compensate for the dynamics or other characteristics of the window 100.

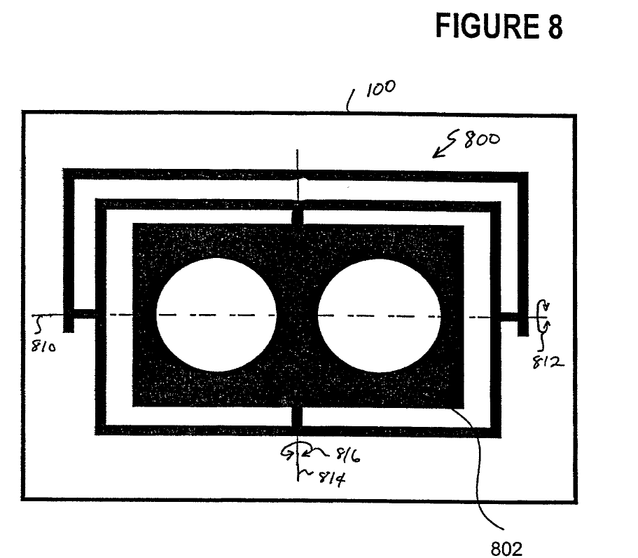

FIG. 8 shows an embodiment of an optical communication terminal 800. The terminal 800 is similar to the terminal 700, except that the terminal 800 has the mirror 702 and 704 removed and the optical subassembly 802 is rotated ninety degrees. In this embodiment, the telescope looks directly out the window rather than looking up towards the ceiling and using a mirror to fold the beam 402 down to the telescope.

Stepper motor actuators can be added to steer the entire terminal 800 (or each of the terminals 400, 500, 600, and 700) and maintain pointing and tracking. For example, the terminal 800 can rotate about an axis 810 in the direction of an arrow 812. Similarly, the terminal 800 can rotate about an axis 814 in the direction of an arrow 816.

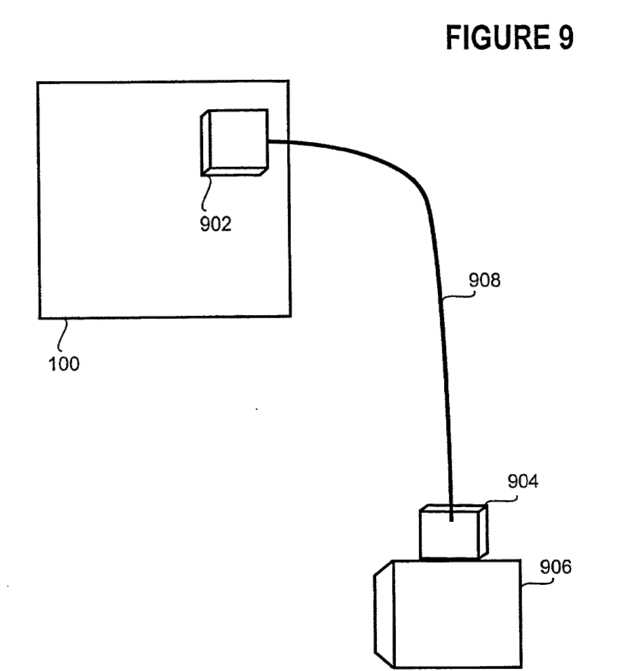

Although several embodiments of the optical communication terminal are described with the electronics subassembly integrated with the optical subassembly, in other embodiments, electronics are separate from the optics subassembly. For example, a cable is run between the electronics (power supply, control electronics, etc.) and the optical-mechanical head. FIG. 9 shows an example embodiment, in which an optical-mechanical head 902 is mounted to the window 100. The electronics 904 are on a table 906, and a cable 908 connects the optical-mechanical head 902 to the electronics 904.

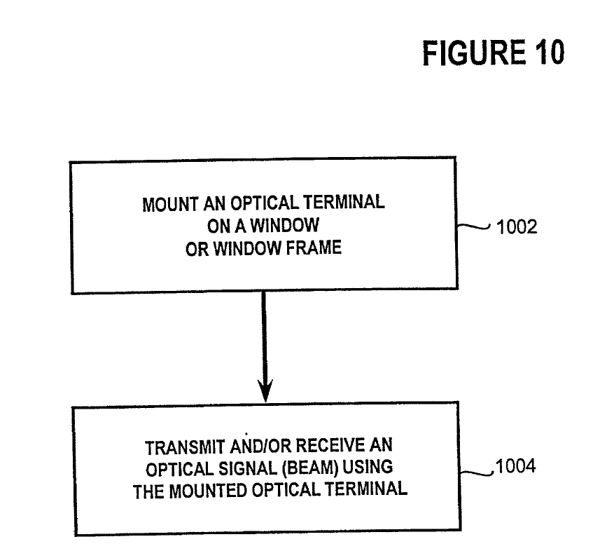

FIG. 10 is a flow chart illustrating an approach to optical communications using a window mountable optical communication terminal. In one embodiment, an optical communication terminal is mounted on to a window (1002), and the terminal transmits and/or receives an optical signal from the free space (1004), as FIG. 10 illustrates. In so mounting, access to the front of the transmitting terminal is restricted.

FIG. 11 is a perspective view of a building window 1100 with several free-space optical terminals 400 mounted to its windowpanes. The window 1100 is partitioned into several regions (or panes) 1102, 1104, 1106, 1108 using a horizontal dividing mechanism 1110 and a vertical dividing mechanism 1112. The added rigidity provided by the partitioning has an effect similar to the mechanical characteristics afforded by having the terminals 400 mounted on four smaller windows. For example, if only one terminal 400 was mounted to the windowpane 104 of FIG. 1, the frame 102 would provide the rigidity. However, the horizontal dividing mechanism 1110 and the vertical dividing mechanism 1112 present advantageous mechanical and structural window characteristics for each of the terminals 400, similar to the mechanical and structural characteristics the frame 102 presents for a terminal 400 mounted on the un-partitioned window 100.

Although mounting of an optical terminal may be described herein with reference to the free-space optical terminal 400, embodiments of the present invention include mounting of the free-space optical terminals 300, 500, 600, 700, 800, as well as the optical-mechanical head 902 and other free-space optical terminals. For simplicity of explanation, various mounting embodiments are generally described herein in the context of mounting the terminal 400.

Windowpane mounting can be achieved by direct bonding of a suitable section of the terminals 400 onto the surface of the window 1100 using window fixtures, such as glue or other adhesive between the windowpane 1102-1108 and a plate 1120 supporting each of the terminals 400. Alternatively, at least a portion of the surface of the terminal 400 can be glued directly onto the surface of the window 1100. Alternatively still, the terminal 400 may be mounted onto a bracket, which is mounted onto the surface of the window 1100. Other window fixtures to mount the terminal 400 to the window 1100 (as well as the window 100) include hook and loop fasteners (e.g., VELCRO™), passive or active vacuum devices, screws or rivets, or other fastener devices.

The terminal 400 may be mounted to the windows 1100 or 100 in a manner such that the aperture of the terminal 400 is parallel to and pressed against the window surface, according to one embodiment. This embodiment allows the terminal 400 to directly face and capture incoming light beams that are incident against the window, thereby maximizing received optical power. Moreover, light beams transmitted from the terminal 400 can proceed from the aperture directly through the window, with minimal (if any) possible structural interference from persons or objects. As described above, the fast steering components of the terminal 400 allow the terminal 400 to be mounted to a window, and to be able to compensate for the window dynamics (such as vibration) and other window characteristics.

FIG. 12 is a perspective view of a building 1200 with four windows 1202, 1204, 1206, and 1208. Each window has a free-space optical terminal 400 mounted to a windowpane (e.g., 1210, 1212, 1214, and 1216, respectively).

According to an embodiment of the present invention, the terminal 400 in the window 1202 is mounted in a corner of the window 1202 using a corner fixture 1220 and is in physical contact with the windowpane 1210. Mounting the terminal 400 in the corner limits the effect of window deflections on optical beam pointing. In one embodiment, the terminal 400 is mounted in the corner at a right angle to benefit from the rigidity of a window frame 1222. The corner fixture 1220 may be any well-known mechanism, such as the various fastening devices described above, to ensure the terminal's 400 placement behind (or in front of, when mounted outdoors) the windowpane 1210.

According to another embodiment, the terminal 400 in the window 1204 may be suspended from the ceiling using a ceiling fixture 1230. At least a portion of the terminal 400 in this embodiment is pressed against (e.g., is in physical contact with) the windowpane 1212 to mechanically isolate the terminal 400 from the ceiling fixture 1230. Thus, when the ceiling and window 1204 vibrate at different frequencies, the mechanical isolation (such as that which can be provided via suitable mechanical coupling connections that would be familiar to those skilled in the art having the benefit of this disclosure) allows the fast steering components of the terminal 400 to adjust based on the window dynamics, rather than the ceiling dynamics.

The ceiling fixture 1230 may be any well-known mechanism to ensure the terminal's 400 placement behind (or in front of) the windowpane 1212. Techniques to maintain the terminal 400 pressed against the windowpane 1212 include direct bonding using glues, hook and loop fasteners, passive or active vacuum devices, screws or rivets, or other fastening techniques and devices.

According to another embodiment, the terminal 400 in the window 1206 is suspended from the wall using a wall fixture 1240. The terminal 400 in this embodiment is pressed against the windowpane 1214 to mechanically isolate the terminal 400 from the wall fixture 1240, in a manner similar to that of the terminal 400 for the window 1204. The wall fixture 1240 may be any well-known mechanism to ensure the terminal 400's placement behind (or in front of) the windowpane 1214. Techniques to maintain the terminal 400 pressed against the windowpane 1214 are similar to those used to maintain the terminal 400 pressed against the windowpane 1212.

According to another embodiment, the terminal 400 in the window 1208 is mounted to the window frame 1222 using a frame fixture 1250. The window frame 1222 can comprise a wooden, metal, plastic, or other material to frame the glass material of the window 1208 and through which the window 1208 is attached to the adjoining wall. The terminal 400 in this embodiment is pressed against the windowpane 1216 to mechanically isolate the terminal 400 from the window frame 1222, in a manner similar to that of the terminal 400 for the windows 1204 and 1206.

The frame fixture 1250 may be any well-known mechanism to ensure the terminal's 400 placement behind (or in front of, when mounted outdoors) the windowpane 1216. Techniques to maintain the terminal 400 pressed against the windowpane 1216 can be similar to those used to maintain the terminal 400 pressed against the windowpane 1212.

FIG. 13 is a perspective view of a building 1300 with a free-space optical terminal 400 mounted to windowpane 1304 of a window 1302 using a floor fixture 1306. The terminal 400 in this embodiment is pressed against the windowpane 1304 to mechanically isolate the terminal 400 from the floor fixture 1306, in a manner similar to that used for the embodiments shown in FIG. 12. The floor fixture 1306 may be any well-known mechanism to support the terminal's 400 placement behind (or in front of) the windowpane 1304. Techniques to maintain the terminal 400 pressed against the windowpane 1304 can be similar to those used to maintain the terminal 400 pressed against the windowpane 1212 in FIG. 12. The floor fixture 1306 may include a pedestal and/or shelf arrangement, for example.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

For instance, one embodiment of the terminal 400 can be made suitable for window mounting by having an increased divergence in transmit and an increased receive field-of-view, so as to compensate for the window dynamics (e.g., vibration) that can potentially cause mis-pointing. The various optical components of the terminal 400 can be designed to provide the appropriate transmit divergence and/or increased field-of-view, such as using lenses having smaller f-numbers to increase the field-of-view.

As another modification, the primary detector 414 may be used in cooperation with a fast steering mechanism to perform tracking based on nutation, in one embodiment. Thus, the detector 414 is used as a position detector, thereby eliminating the need to split off (and waste) light for a separate position detector. The separate position detector and extra beam splitter, therefore, are not required, which results in further compactness and reduced weight of the terminal 400.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
a free-space optical communication terminal having:
a mounting fixture to allow at least a portion of the communication terminal to be mounted to a window; and
a feature to allow the communication terminal to compensate for characteristics of the window onto which the communication terminal is mounted via the mounting fixture.

2. The apparatus of claim 1 wherein the mounting fixture allows the communication terminal to be mounted to an indoor surface of the window.

3. The apparatus of claim 1 wherein the mounting fixture allows the communication terminal to be mounted to an outdoor surface of the window.

4. The apparatus of claim 1 wherein the mounting fixture comprises glue between the portion of the communication terminal and a surface of the window.

5. The apparatus of claim 1 wherein the mounting fixture comprises a plate to support the communication terminal, and wherein the plate is structured to be attached to the window.

6. The apparatus of claim 1 wherein the mounting fixture comprises a fastener device to fasten the portion of the communication terminal to a surface of the window.

7. The apparatus of claim 6 wherein the fastener device comprises at least one of a hook and loop fastener, a passive vacuum device, an active vacuum device, a bracket, a screw, and a rivet.

8. The apparatus of claim 1 wherein one of the characteristics of the window includes vibration of the window, and wherein the feature to allow the communication terminal to compensate for characteristics of the window includes a fast steering mechanism to compensate for positional changes of the communication terminal caused by the vibration of the window.

9. The apparatus of claim 8 wherein the fast steering mechanism comprises a steering mirror to steer a light beam received by the communication terminal onto a position sensor, the steering mirror being configured to move to maintain alignment of the light beam on the position sensor, as positional changes of the communication terminal occur as a result of the vibration of the window.

10. The apparatus of claim 8 wherein the fast steering mechanism comprises:
a mirror to direct a light beam received by the communication terminal onto a position sensor; and
an actuator to adjust a position of an optical subassembly of the communication terminal, if the communication terminal undergoes a positional change as a result of the vibration of the window, as detected by the position sensor via the light beam directed onto the position sensor by the mirror.

11. The apparatus of claim 1 wherein one of the characteristics of the window includes a stress limit of the window, and wherein the feature to allow the communication terminal to compensate for characteristics of the window includes a weight of the communication terminal that is selected to be within the stress limit of the window.

12. The apparatus of claim 1 wherein one of the characteristics of the window includes an area of the window, and wherein the feature to allow the communication terminal to compensate for characteristics of the window includes a size of the communication terminal that is selected to reduce occupation of the area of the window.

13. The apparatus of claim 1 wherein the feature to allow the communication terminal to compensate for characteristics of the window includes a common aperture to transmit into free space and to receive from free space an optical signal having a transmit beam at a first wavelength and a receive beam at a second wavelength, respectively.

14. The apparatus of claim 1, further comprising a ceiling fixture capable of being attached to a ceiling adjacent to the window and from which the communication terminal can be coupled, the portion of the communication terminal capable of being placed in contact with the window via the mounting fixture in a manner that mechanically isolates the communication terminal from the ceiling fixture.

15. The apparatus of claim 1, further comprising a wall fixture capable of being attached to a wall adjacent to the window and to which the communication terminal can be coupled, the portion of the communication terminal capable of being placed in contact with the window via the mounting fixture in a manner that mechanically isolates the communication terminal from the wall fixture.

16. The apparatus of claim 1, further comprising a frame fixture capable of being attached to a frame adjacent to the window and to which the communication terminal can be coupled, the portion of the communication terminal capable of being placed in contact with the window via the mounting fixture in a manner that mechanically isolates the communication terminal from the frame fixture.

17. The apparatus of claim 1, further comprising a floor fixture capable of being attached to a floor adjacent to the window and to which the communication terminal can be coupled, the portion of the communication terminal capable of being placed in contact with the window via the mounting fixture in a manner that mechanically isolates the communication terminal from the floor fixture.

18. The apparatus of claim 1 wherein the mounting fixture comprises a corner fixture that allows the portion of the communication terminal to be mounted adjacent to a corner of the window.

19. An apparatus usable in a free-space optical communication system, the apparatus comprising:
a free-space optical communication terminal having:
a mounting fixture to mount at least a portion of the communication terminal to a surface of a window to allow the communication terminal to receive a light beam from the free-space optical communication system; and
a feature to allow the communication terminal to compensate for dynamics of the window onto which the communication terminal is mounted via the mounting fixture.

20. The apparatus of claim 19 wherein the surface of the window comprises an indoor surface, and wherein the mounting fixture is structured to mount the communication terminal to the indoor surface of the window.

21. The apparatus of claim 19 wherein the mounting fixture comprises glue between the portion of the communication terminal and the surface of the window.

22. The apparatus of claim 19 wherein the mounting fixture comprises a plate to support the communication terminal, and wherein the plate is structured to be attached to the surface of the window.

23. The apparatus of claim 19 wherein the mounting fixture comprises a fastener device to fasten the portion of the communication terminal to the surface of the window.

24. The apparatus of claim 19 wherein the dynamics of the window include vibration of the window, and wherein the feature to allow the communication terminal to compensate for the dynamics of the window includes a fast steering mechanism to compensate for positional changes of the communication terminal caused by the vibration of the window.

25. The apparatus of claim 19 wherein the window has characteristics including a stress limit and an area, the communication terminal further including additional features to compensate for the characteristics of the window, the additional features comprising:
a weight of the communication terminal that is selected to be within the stress limit of the window; and
a size of the communication terminal that is selected to reduce occupation of the area of the window.

26. The apparatus of claim 19 wherein the window has characteristics including a stress limit and an area, the communication terminal further including a common aperture to transmit into free space and to receive from free space an optical signal having a transmit beam at a first wavelength and the light beam at a second wavelength, respectively, the common aperture being configured to allow the communication terminal to be within the stress limit of the window and to reduce occupation of the area of the window.

27. The apparatus of claim 19, further comprising another fixture capable of being attached to a building structure adjacent to the window and to which the communication terminal can be coupled, the portion of the communication terminal capable of being placed in contact with the window via the mounting fixture in a manner that mechanically isolates the communication terminal from the another fixture.

28. An apparatus, comprising:
a free-space optical communication transceiver having:
a mounting fixture to mount at least a portion of the communication transceiver to a surface of a window to allow the communication transceiver to communicate with the free-space optical communication system;
a feature to allow the communication transceiver to compensate for dynamics of the window onto which the communication transceiver is mounted via the mounting fixture; and
a common aperture to transmit into free space and to receive from free space an optical signal having a transmit beam at a first wavelength and a receive beam at a second wavelength, respectively.

29. The apparatus of claim 28 wherein the feature to allow the communication terminal to compensate for dynamics of the window comprises a tracking system including a movable steering mechanism and a position sensor, wherein the movable steering mechanism is operatively coupled to receive the optical signal from free space and to steer the optical signal onto the position sensor.

30. The apparatus of claim 28 wherein the movable steering mechanism includes at least one of a movable steering mirror, lens, and gimbal system with actuators.

31. The apparatus of claim 28 wherein the position sensor includes at least one of a quadrant-cell detector, a lateral effect cell, a fast charge coupled device (CCD), a complementary metal oxide semiconductor (CMOS) camera, and a data detector in cooperation with a steering mechanism to perform nutation.

32. The apparatus of claim 29, further comprising a controller operatively coupled to process an output of the position sensor.

33. The apparatus of claim 28 wherein the communication transceiver further comprises:
a first beam splitter;
a second beam splitter; and
a detector, wherein the first beam splitter is operatively coupled to separate the optical signal into the transmit beam and the receive beam and to direct the receive beam to the second beam splitter, and the second beam splitter is operatively coupled to direct a first portion of the receive beam to the position sensor and a second portion of the receive beam to the detector.

34. The apparatus of claim 33, further comprising a filter operatively coupled to filter unwanted signals from the receive beam prior to direction of the receive beam to the second beam splitter.

35. The apparatus of claim 28, further comprising:
a beam splitter; and
opto-electronics, wherein the opto-electronics are operatively coupled to direct the transmit beam to the beam splitter.

36. The apparatus of claim 35, further comprising an optical fiber operatively coupled between the opto-electronics and the beam splitter.

37. The apparatus of claim 35 wherein the beam splitter is structured to combine the transmit beam and the receive beam into the optical signal.

38. The apparatus of claim 37, further comprising:
a movable steering mechanism;
a lens; and
a mirror, wherein the movable steering mechanism is operatively coupled to direct the optical signal from the beam splitter to the lens, wherein the lens is operatively coupled to focus the optical signal onto the mirror, and wherein the mirror is operatively coupled to direct the optical signal to free space.

39. The apparatus of claim 28, further comprising:
opto-electronics;
a light source; and
a beam splitter, wherein the opto-electronics are operatively coupled to direct an electrical signal to the light source, wherein the light source is configured to convert the electrical signal to the transmit beam and to direct the transmit beam to the beam splitter, and wherein the beam splitter is structured to combine the transmit beam and the receive beam into the optical signal.

40. The apparatus of claim 29 wherein the mirror is further operatively coupled to fold the optical signal at a predetermined angle.

41. The apparatus of claim 29 wherein the steering mechanism comprises at least one actuator driven by at least one precision motion device.

42. The apparatus of claim 28 wherein the mounting fixture comprises glue between the portion of the communication transceiver and the surface of the window.

43. The apparatus of claim 28 wherein the mounting fixture comprises a fastener device to fasten the portion of the communication transceiver to the surface of the window.

44. The apparatus of claim 28 wherein the dynamics of the window include vibration of the window, and wherein the feature to allow the communication transceiver to compensate for the dynamics of the window includes a fast steering mechanism to compensate for positional changes of the communication transceiver caused by the vibration of the window.

45. The apparatus of claim 28 wherein the window has characteristics including a stress limit and an area, the communication transceiver further including additional features to compensate for the characteristics of the window, the additional features comprising:
a weight of the communication transceiver that is selected to be within the stress limit of the window; and
a size of the communication transceiver that is selected to reduce occupation of the area of the window.

46. The apparatus of claim 28, further comprising another fixture capable of being attached to a building structure adjacent to the window and to which the communication transceiver can be coupled, the portion of the communication transceiver capable of being placed in contact with the window via the mounting fixture in a manner that mechanically isolates the communication transceiver from the another fixture.

47. A system, comprising:
a first free-space optical communication transceiver having a common aperture to transmit into free space and to receive from free space a transmit beam at a first wavelength and a receive beam at a second wavelength, respectively; and
a second free-space optical transceiver to receive the transmit beam from the first free-space optical communication transceiver via free space and to transmit the receive beam to the first free-space optical communication transceiver via free space,
wherein at least one of the communication transceivers includes:
a mounting fixture to allow at least a portion of that communication transceiver to be mounted to a window; and
a feature to allow that communication transceiver to compensate for characteristics of the window onto which that communication transceiver is mounted via the mounting fixture.

48. The system of claim 47 wherein the mounting fixture comprises glue between the portion of the communication transceiver and a surface of the window.

49. The system of claim 47 wherein the mounting fixture comprises a fastener device to fasten the portion of the communication transceiver to a surface of the window.

50. The system of claim 47 wherein the characteristics of the window include vibration of the window, and wherein the feature to allow the communication transceiver to compensate for the characteristics of the window includes a fast steering mechanism to compensate for positional changes of the communication transceiver caused by the vibration of the window.

51. The system of claim 47 wherein the characteristics of the window includes a stress limit and an area, and wherein the feature to compensate for the characteristics of the window comprises:
a weight of the communication transceiver that is selected to be within the stress limit of the window; and
a size of the communication transceiver that is selected to reduce occupation of the area of the window.

52. The system of claim 47 wherein the at least one communication transceiver further comprises another fixture capable of being attached to a building structure adjacent to the window and to which the communication transceiver can be coupled, the portion of the communication transceiver capable of being placed in contact with the window via the mounting fixture in a manner that mechanically isolates that communication transceiver from the another fixture.

53. The system of claim 47 wherein the feature to compensate for the characteristics of the window comprises an increased divergence in transmit and an increased receive field-of-view.

54. The system of claim 47 wherein the characteristics of the window includes a stress limit, and wherein the feature to compensate for the characteristics of the window comprises a common aperture for transmit and receive beams and that can accommodate a single steering mechanism to allow the communication transceiver to be within the stress limit.

55. A method, comprising:
mounting a free-space optical communication terminal to a windowpane;
transmitting a first light beam into free space using the free-space optical communication terminal mounted to the windowpane; and
receiving a second light beam from free space using the free-space optical communication terminal mounted to the windowpane.

56. The method of claim 55 wherein mounting the free-space optical communication terminal to the windowpane includes directly gluing at least a portion of the free-space optical communication terminal to a surface of the windowpane.

57. The method of claim 55 wherein mounting the free-space optical communication terminal to the windowpane includes fastening at least a portion of the free-space optical communication terminal to a surface of the windowpane with a fastener device.

58. The method of claim 55, further comprising coupling the free-space optical communication terminal to a building structure adjacent to the windowpane via a fixture in a manner where at least a portion of the free-space optical communication terminal is in contact with the windowpane while mechanically isolating the free-space optical communication terminal from the fixture.

59. The method of claim 55 wherein mounting the free-space optical communication terminal to the windowpane includes mounting the free-space optical communication terminal adjacent to a corner of the windowpane.

60. The method of claim 55, further comprising mounting a plurality of free-space optical communication terminals to at least one of a corresponding plurality of windowpanes and to a single windowpane.
